(19) United States
(12) Patent Application Publication
(10) Pub. No.: US 2012/0240782 A1
(43) Pub. Date: Sep. 27, 2012

(54) STEAM MECHANISM OF BEVERAGE MAKING DEVICE

(76) Inventor: DANIEL YANG, TAOYUAN COUNTY (TW)

(21) Appl. No.: 13/052,339

(22) Filed: Mar. 21, 2011

(51) Int. Cl. A47J 31/44

(52) U.S. Cl. 99/288

(57) ABSTRACT

A steam mechanism of a beverage making device includes a barrel, a steam pipe and a check valve. The barrel has a chamber therein. The steam pipe is straightly disposed in the chamber of the barrel and eccentric with respect to the barrel. The steam pipe has a room therein. The room has an inlet and a plurality of outlets. The check valve is located at the inlet of the steam pipe to control steam which enters the room in one-way direction through the inlet of the steam pipe. The present invention provides an eddy effect to the beverage in the barrel.

### BACKGROUND OF THE INVENTION

1. Field of the Invention

The present invention relates to a steam mechanism of a beverage making device, and more particularly to a steam mechanism to eddy the beverage in a barrel.

2. Description of the Prior Art

Taiwan Utility Model Patent No. M308725 discloses a steam mechanism of a beverage making device, which comprises a water inlet unit and a water outlet unit. The water inlet unit comprises a water inlet pipe and a water distribution plate at its bottom. The water outlet unit is located under the water inlet unit and includes a soaking area and a water outlet. The water inlet unit is provided with a steam pipe. The distal end of the steam pipe is provided a steam nozzle. The steam nozzle passes through the water distribution plate of the water inlet unit and enters the soaking area of the water outlet unit. By the steam nozzle, the steam and water enter the soaking area together to stir the hot water for making beverage.

The steam from the steam nozzle of the conventional steam mechanism enters the soaking area from top to bottom. Because there is a certain amount of beverage in the soaking area, the steam only blows the top part of the beverage and is unable to provide an eddy effect. This cannot enhance the thickness and uniformity of the beverage. Accordingly, the inventor of the present invention has devoted himself based on his many years of practical experiences to solve this problem.

### SUMMARY OF THE INVENTION

The present invention is to solve the problem that the conventional steam mechanism is unable to eddy beverage and cannot enhance the thickness and uniformity of beverage.

According to the present invention, there is provided a steam mechanism of a beverage making device. The steam mechanism comprises a barrel, a steam pipe and a check valve.

The barrel has a chamber therein.

The steam pipe is straightly disposed in the chamber of the barrel and eccentric with respect to the barrel. The steam pipe has a room therein. The room has an inlet and a plurality of outlets.

The check valve is located at the inlet of the steam pipe to control steam which enters the room in one-way direction through the inlet of the steam pipe.

Preferably, the barrel further comprises a filter disposed in the chamber. The filter has a plurality of apertures thereon.

Preferably, the steam pipe further has a through hole and a plug inserted in the through hole.

Compared to the prior art, the present invention has the following advantages:

The steam of the present invention comes from the outlets of the eccentric steam pipe to provide an eddy effect so as to enhance the thickness and uniformity of beverage.

The present invention provides a filter to make tea. The steam from the steam pipe enters the filter through the apertures to eddy the hot water in the filter so as to expedite the soaking of tea. After making tea, the filter can be removed from the chamber of the barrel for cleaning.

The through hole of the steam pipe is provided with the plug. The plug is used for cleaning of the steam pipe to prevent the room and the outlet of the steam pipe from being blocked.

### BRIEF DESCRIPTION OF THE DRAWINGS

FIG. 1 is a perspective view of a preferred embodiment of the present invention;

FIG. 2 is a cross-sectional view of the preferred embodiment of the present invention;

FIG. 3 is a schematic view of the preferred embodiment of the present invention when in use; and

FIG. 4 is a schematic view of another use of the preferred embodiment of the present invention.

### DETAILED DESCRIPTION OF THE PREFERRED EMBODIMENTS

Embodiments of the present invention will now be described, by way of example only, with reference to the accompanying drawings.

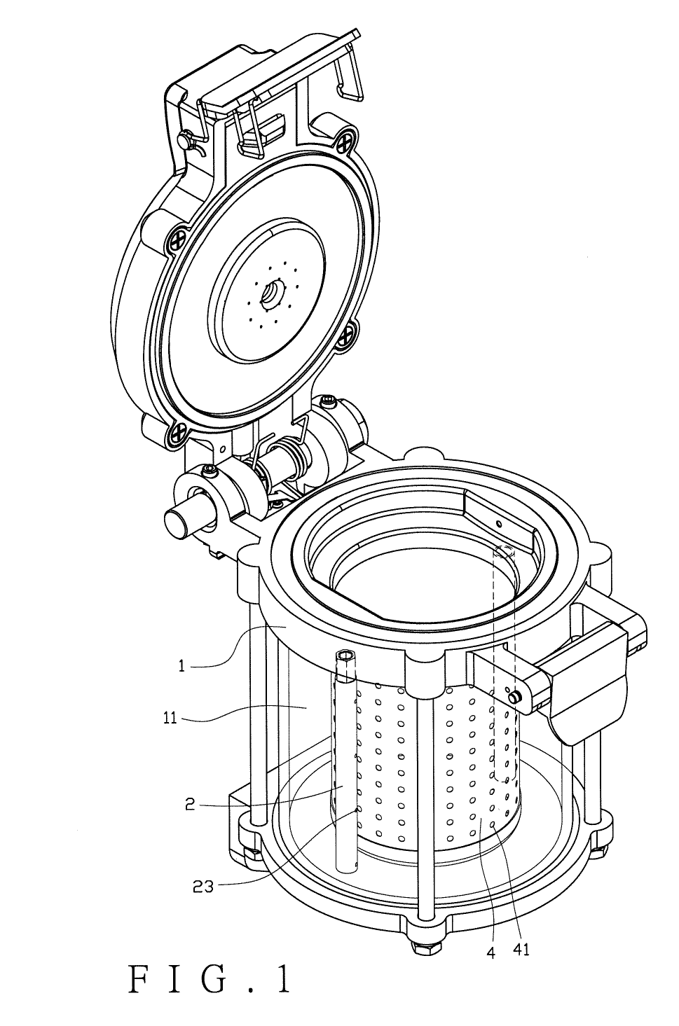

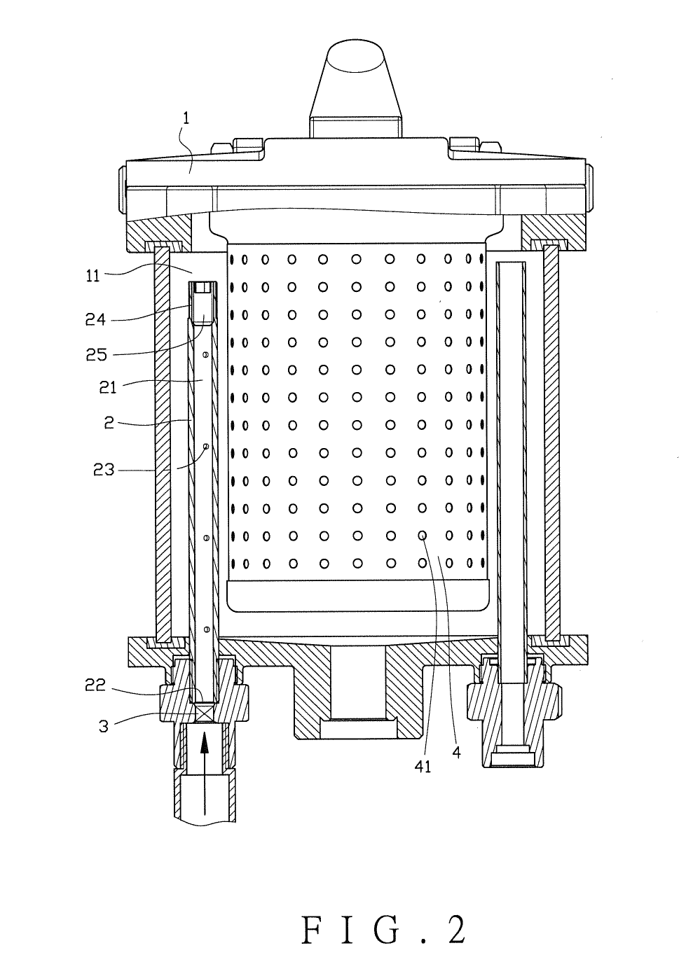

As shown in FIG. 1 and FIG. 2, a steam mechanism of a beverage making device according to a preferred embodiment of the present invention comprises a barrel (1), a steam pipe (2) and a check valve (3).

The barrel (1) has a chamber (11) therein.

The steam pipe (2) is straightly disposed in the chamber (11) of the barrel (1) and is eccentric with respect to the barrel (1).

The steam pipe (2) has a room (21) therein. The room (21) has an inlet (22) and a plurality of outlets (23).

The check valve (3) is located at the inlet (22) of the steam pipe (2) to control steam which enters the room (21) in one-way direction through the inlet (22) of the steam pipe (2).

The barrel (1) further comprises a filter (4) disposed in the chamber (11). The filter (4) has a plurality of apertures (41) thereon.

The steam pipe (2) further has a through hole (24) and a plug (25) inserted in the through hole (24). The plug (25) is used for cleaning of the steam pipe (2) to prevent the inside of the steam pipe (2) from being blocked.

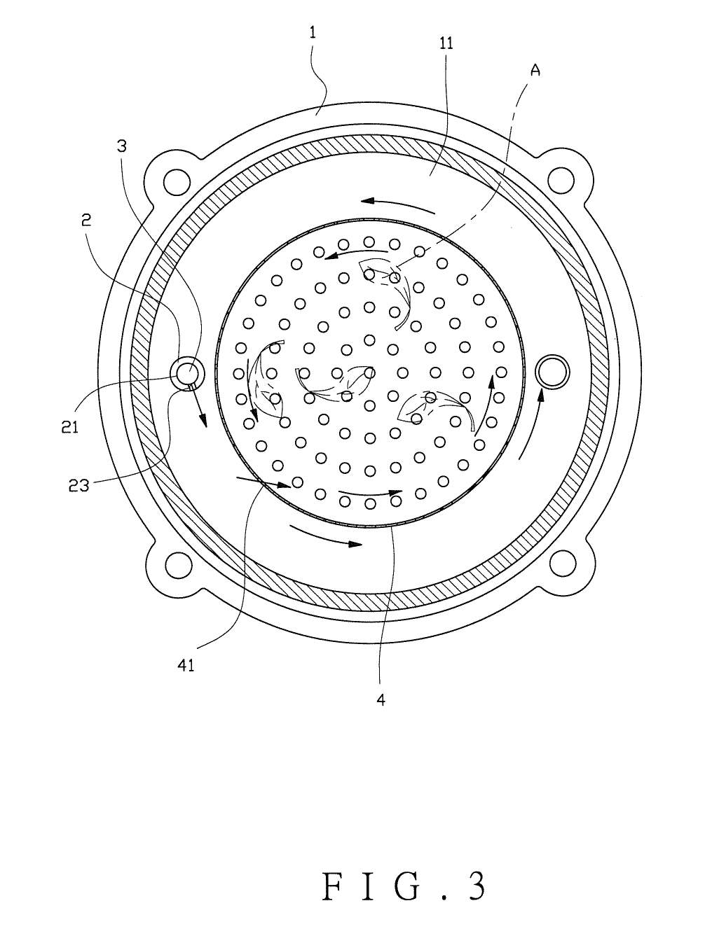

As shown in FIG. 2 and FIG. 3, when in use, place tea leaves (A) in the filter (4) and pour hot water. Steam enters the room (21) through the inlet (22) of the steam pipe (2). Because the inlet (22) of the steam pipe (2) is provided with the check valve (3), the steam won't flow back. The steam enters the chamber (11) of the barrel (1) through the outlets (23) to eddy the hot water, such that the hot water with steam enters the filter (4) through the plurality of apertures (41) of the filter (4). Similarly, the hot water inside the filter (4) also eddies to stir the tea leaves (A) to enhance the thickness and uniformity of tea.

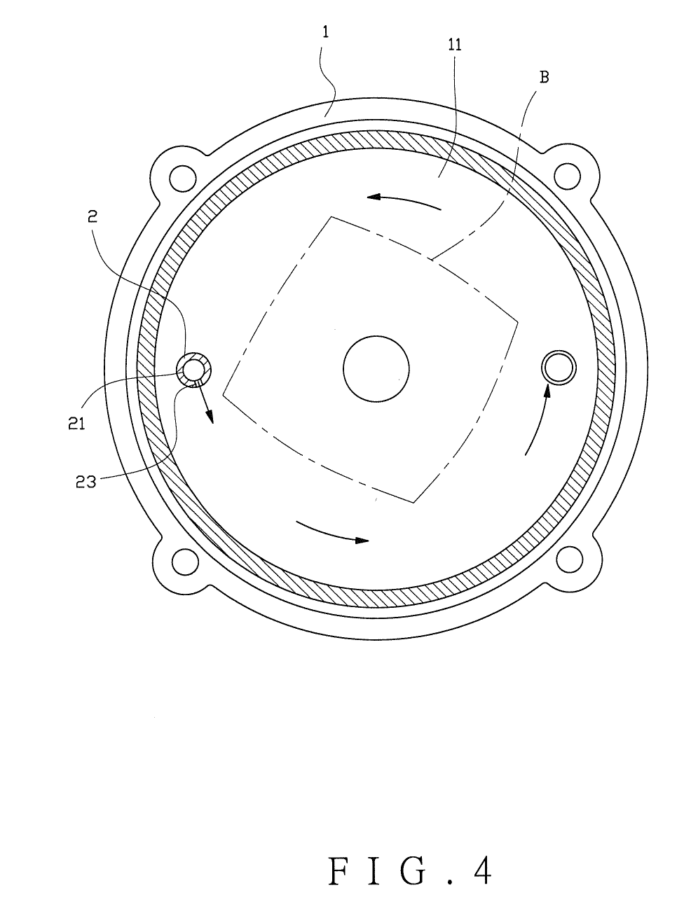

FIG. 4 is a schematic view of another use of the present invention. A tea bag (B) is directly placed in the chamber (11) of the barrel (1), without the need to filter. Hot water is poured into the barrel (1) and steam flows from the outlet (23) of the steam pipe (2), such that the hot water in the chamber (11) eddies to expedite the soaking of the tea bag (B) so as to enhance the thickness and uniformity of the tea.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A steam mechanism of a beverage making device,
a barrel having a chamber therein;
a steam pipe straightly disposed in the chamber of the barrel, the steam pipe being eccentric with respect to the barrel, the steam pipe having a room therein, the room having an inlet and a plurality of outlets; and
a check valve located at the inlet of the steam pipe to control steam which enters the room in one-way direction through the inlet of the steam pipe.

2. The steam mechanism of a beverage making device as claimed in claim 1, wherein the barrel further comprises a filter disposed in the chamber, the filter having a plurality of apertures thereon.

3. The steam mechanism of a beverage making device as claimed in claim 1, wherein the steam pipe further has a through hole and a plug inserted in the through hole.
